(19) United States
(12) Patent Application Publication
(10) Pub. No.: US 2006/0041646 A1
(43) Pub. Date: Feb. 23, 2006

(54) System and method for automatically adjusting computer system times through a network

(75) Inventor: Jian-Feng Wang, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/997,361

(22) Filed: Nov. 23, 2004

(30) Foreign Application Priority Data
Aug. 20, 2004 (TW) 93125143

(51) Int. Cl. G06F 15/177

(52) U.S. Cl. 709/220

(57) ABSTRACT

A system for automatically adjusting computer system times through a network includes one or more computers (1) to be adjusted, and a time server (3). Each computer includes: a setting determining module (10) for determining whether a user has set a new time zone and a new time format; a command generating module (12) for generating a time obtaining command, and transmitting the time obtaining command to the time server; a searching module (14) for searching a time difference value of a destination in a time difference table; a converting module (15) for converting a current time received from the time server into a system time of the destination, and converting the format of the current time into the preset time format; and a system time adjusting module (16) for adjusting the system time of the computer. A related method is also disclosed.

### BACKGROUND OF THE INVENTION

1. Field of the Invention

The present invention relates to configuring the system time of a computer according to the time zone in which the computer is to be located, and particularly to a system and method for automatically adjusting a computer's system time through an electronic network.

2. Description of the Related Art

Accurate computer system times are required in a wide variety of applications, such as in managing and tracking electronic mail (email), timing back-ups of data on a network, synchronizing communications between clients and servers, and managing multimedia teleconferences. However, clients, servers and users are often located in different time zones, and the time differences must be taken into account appropriately. Further, the system times of most computers are subject to a certain amount of error, or “drift.”

Various techniques have been developed to adjust the system times of computers. Traditional techniques involve operators manually adjusting the system times. However, these techniques are inconvenient for operators and are subject to human error.

With the recent rapid development of network technology, techniques for adjusting system times through networks are gradually replacing traditional methods. A server maintains a highly accurate system time, and provides an accurate system time reading to other computers through a network. Methods for adjusting the system time of a computer through a network are disclosed in patents such as U.S. Pat. No. 6,311,283 issued on Oct. 30, 2001 and entitled “Need based synchronization of computer system time clock to reduce adjusting on network server.” This patent discloses a method and an apparatus for performing needs based synchronization of a time maintained by a computer system. Each computer system adjusts its time by accessing a time server via a network.

The above-described network-enabled methods involve adjusting system times of computers through reading a time server. However, these methods are inadequate when newly manufactured computers are shipped to a particular marketplace in a different time zone. Generally, it is desirable that the computers are appropriately pre-adjusted prior to dispatch. The above-described methods do not take into account the difference between the time zone in which the computer manufacturer is located and the time zone in which the marketplace is located. In addition, the above-described methods do not address any conversion of the system time format of each computer that may be needed between the time zones. For example, in the country of the manufacturer, it may be customary for time to be expressed in a twelve-hour format; whereas in the country of the marketplace, it may be customary for time to be expressed in a twenty-four hour format. In such circumstances, upon arrival at destination, the system times are incorrect because they were adjusted to local time prior to dispatch, and the time format of each computer is inappropriate.

Therefore, what is needed is a system and method for automatically adjusting computer system times through a network, which not only can adjust computer system times, but also provide conversions of the time zone and the time format.

### SUMMARY OF THE INVENTION

A main objective of the present invention is to provide a system and method for automatically adjusting computer system times through a network, which converts time zones and time formats appropriately.

To achieve the above objective, a system for automatically adjusting computer system times through a network in accordance with a preferred embodiment of the present invention comprises one or more computers whose system times are to be adjusted, and a time server. Each computer stores a time difference table containing information on time zones and time difference values. The computer comprises a plurality of software function modules: a setting determining module for determining whether a user has set a new time zone and a new time format for a computer according to its destination; a command generating module for generating a time obtaining command, and transmitting the time obtaining command to the time server; a searching module for searching a time difference value of the destination in the time difference table; a converting module for converting a current time received from the time server into a system time of the destination according to the formula: system time of the destination=current time+time difference value of the destination, and converting the format of the current time into the preset time format; and a system time adjusting module for adjusting system time of the computer according to the conversion.

Further, the present invention provides a preferred method for automatically adjusting computer system times through a network. The method comprises the steps of: (a) determining whether a user has set a new time zone and a new time format for a computer according to its destination; (b) receiving new settings for the time zone and the time format and storing the new settings, if the user has set a new time zone and a new time format; (c) generating a time obtaining command, and transmitting the time obtaining command to the time server; (d) obtaining a current time of the time server according to the time obtaining command, and transmitting the current time to the corresponding computer; (e) searching a time difference value of the destination in the time difference table, if the user has set a new time zone and a new time form a; (f) converting the current time received from the time server into a system time of the destination according to the formula, and converting a format of the current time into the new time format or a previously set time format; (g) adjusting the system time of the computer; (h) returning to step (a) if there is another computer whose system time needs to be adjusted; (i) repeating steps (b) through (h) for the other computer, if the user has set a new time zone and a new time format for the other computer according to its destination; and (j) repeating steps (c), (d), (f), (g) and (h) for the other computer, if the user has not set a new time zone and a new time format for the other computer according to its destination.

Other objects, advantages and novel features of the present invention will be drawn from the following detailed description of the preferred embodiment and preferred method of the present invention with the attached drawings, in which:

### BRIEF DESCRIPTION OF THE DRAWINGS

FIG. 1 is a simplified block diagram of hardware configuration of a system for automatically adjusting computer system times through a network in accordance with the preferred embodiment of the present invention;

FIG. 2 is a schematic diagram of main software function modules of a computer of the system of FIG. 1; and

FIG. 3 is a flowchart of the preferred method for utilizing the system of FIG. 1.

### DETAILED DESCRIPTION OF THE PREFERRED EMBODIMENT

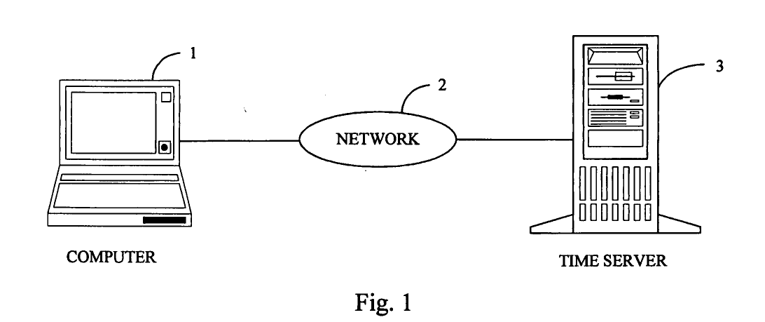

FIG. 1 is a simplified block diagram of hardware configuration of a system for automatically adjusting system times of electronic devices like computers through a network (hereinafter, “the system”) in accordance with the preferred embodiment of the present invention. The system comprises a plurality of computers 1 (only one shown) whose system times are to be adjusted, a network 2, and a time server 3. Each computer 1 is connected to the time server 3 and the other computers 1 through the network 2. The network 2 may be an intranet, the Internet or any other suitable type of communication network.

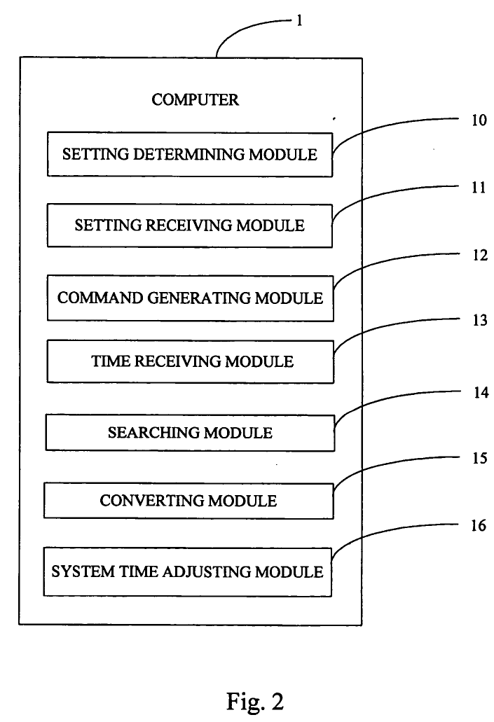

In the preferred embodiment, each computer 1 is a brand personal computer (PC) that has just been assembled at a factory, and is scheduled to be shipped to a particular marketplace. However, this should not be construed as limiting the invention in any way, and the invention and following description is equally applicable to any other computing devices whose system times need to be adjusted for any of various reasons. The computer 1 stores a time difference table containing information on time zones and time difference values. Each time zone corresponds to a time difference value. The time difference value is a difference value between a base time zone (e.g., a time zone in which the computer manufacturer is located) and a designated time zone (e.g., a time zone in which the marketplace is located). The time difference value of the base time zone is set as zero, and the time difference value of any marketplace is either a positive number or a negative number. Therefore, before the computer 1 is shipped to the designated marketplace in a different time zone, the system time of the computer 1 needs to be adjusted to a system time of the marketplace according to the formula: system time of the marketplace=current time of the base time zone+time difference value of the marketplace. For example, when the computer manufacturer is in China with a current system time “10:30:20,” and the marketplace is in Japan with a time difference value “1,” the system time of the computer 1 to be shipped to Japan is adjusted to “11:30:20” according to the formula. The computer 1 comprises a plurality of software function modules (described in detail below in relation to FIG. 2), for searching the time difference value of the marketplace in the time difference table, converting a current time received from the time server 3 into a preset time-display format, and adjusting the system time of the computer 1. The preset time format may, for example, be a twelve-hour format or a twenty-four hour format. The time server 3 is used for obtaining a current time thereof and transmitting the current time to a corresponding computer 1, according to a time obtaining command received from the computer 1.

FIG. 2 is a schematic diagram of main software function modules of any computer of the system of FIG. 1. The computer 1 comprises a setting determining module 10, a setting receiving module 11, a command generating module 12, a time receiving module 13, a searching module 14, a converting module 15, and a system time adjusting module 16. The setting determining module 10 is for determining whether a user has set a new time zone and a new time format for the computer 1 according to its marketplace. The setting receiving module 11 is for receiving the new settings for the time zone and the time format of the computer 1, and storing the new settings. The command generating module 12 is for generating a time obtaining command, and transmitting the time obtaining command to the time server 3. The time receiving module 13 is for receiving a current time from the time server 3. The searching module 14 is for searching a corresponding time difference value of the marketplace in a time difference table, and storing the time difference value. The converting module 15 is for converting the current time received from the time server 3 into a system time of the marketplace according to the formula: system time of the marketplace=current time+time difference value of the marketplace. The converting module 15 is also for converting a format of the current time into the preset time format. The system time adjusting module 16 is for adjusting the system time of the computer 1, and determining whether there is any other computer 1 which needs to have its system time adjusted.

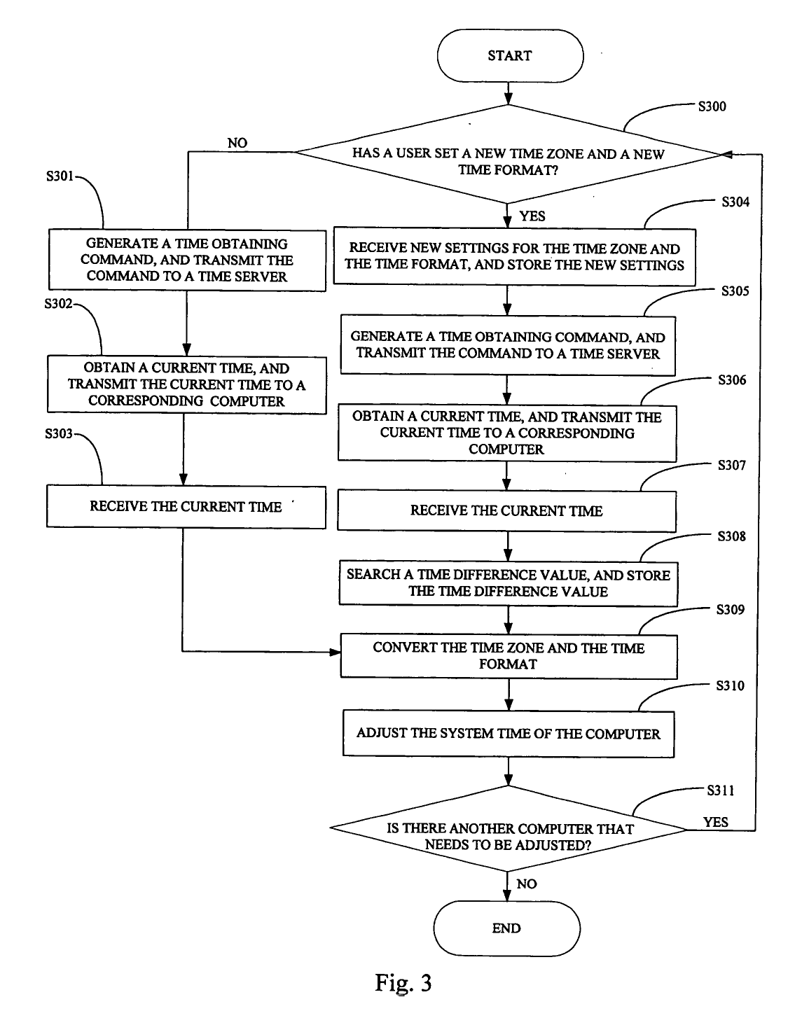

FIG. 3 is a flowchart of the preferred method for utilizing the system. In step S300, the setting determining module 10 determines whether a user has set a new time zone and a new time format for the computer 1 to be adjusted according to a target marketplace. It should be noted that when the system is utilized for the first time in respect of a first computer 1, the user must set a new time zone and a new time format for such computer 1. However, when the system is utilized in respect of a second or subsequent computer 1, the user may or may not set a new time zone and a new time format for such computer 1. If the user has set a new time zone and a new time format, the procedure goes directly to step S304 described below. In contrast, if the user has not set a new time zone and a new time format for the computer 1, then the computer 1 accesses a time zone and a time format previously set by the user, and a time difference value of the marketplace previously searched (see step S308 below). Such time zone, time format and time difference value are available via any computer 1 which has already had its system time adjusted. In step S301, the command generating module 12 generates a time obtaining command, and transmits the time obtaining command to the time server 3. In step S302, the time server 3 receives the time obtaining command, obtains a current time from itself, and transmits the current time to the computer 1. In step S303, the time receiving module 13 receives the current time from the time server 3, whereupon the procedure goes directly to step S309 described below.

In step S304, the setting receiving module 11 receives the new settings for the time zone and the time format of the computer 1, and stores the new settings in the computer 1. In step S305, the command generating module 12 generates a time obtaining command, and transmits the time obtaining command to the time server 3. In step S306, the time server 3 receives the time obtaining command from the computer 1, obtains a current time from itself, and transmits the current time to the computer 1. In step 307, the time receiving module 13 receives the current time from the time server 3. In step S308, the searching module 14 searches a time difference value of the marketplace in a time difference table, and stores the time difference value.

In step S309, the converting module 15 converts the current time received from the time server 3 into a system time of the marketplace according to the formula: system time of the marketplace=current time+time difference value of the marketplace. The converting module 15 also converts the format of the current time into the preset time format. The preset time format may, for example, be a twelve-hour format or a twenty-four hour format. In step S310, the system time adjusting module 16 adjusts the system time of the computer 1 according to the conversion result. In step S311, the system time adjusting module 16 determines whether there is any other computer 1 whose system time needs to be adjusted. If there is another computer 1 whose system time needs to be adjusted, the procedure returns to step S300 described above. In contrast, if the system times of all the computers 1 have been adjusted, the procedure is finished.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for automatically adjusting computer system times through a network, the system comprising one or more computers whose system times are to be adjusted and a time server connected to said computers through a network, wherein each computer comprises:
a setting determining module for determining whether a user has set a new time zone and a new time format for a computer according to its destination;
a command generating module for generating a time obtaining command, and transmitting the time obtaining command to the time server;
a searching module for searching a time difference value of the destination;
a converting module for converting a current time received from the time server into a system time of the destination according to the formula: system time of the destination=current time+time difference value of the destination, and for converting the format of the current time into the preset time format; and
a system time adjusting module for adjusting the system time of the computer.

2. The system according to claim 1, wherein each computer further comprises a setting receiving module for receiving new settings for the computer.

3. The system according to claim 1, wherein each computer further comprises a time receiving module for receiving the current time from the time server.

4. The system according to claim 1, wherein each computer stores a time difference table.

5. The system according to claim 4, wherein the time difference table contains information on time zones and time difference values.

6. The system according to claim 1, wherein the time difference value of the destination is the difference in times between a base time zone in which the computer is currently located and a time zone in which the destination is located.

7. The system according to claim 6, wherein the time difference value of the base time zone is set as zero, and the time difference value of the destination is either a positive number or a negative number.

8. The system according to claim 1, wherein the preset time format is selected from the group consisting of a twelve-hour format and a twenty-four hour format.

9. A computer-based method for automatically adjusting computer system times through a network, comprising the steps of:
(a) determining whether a user has set a new time zone and a new time format for a computer according to its destination;
(b) receiving new settings for the time zone and the time format and storing the new settings, if the user has set a new time zone and a new time format;
(c) generating a time obtaining command, and transmitting the time obtaining command to a time server;
(d) obtaining a current time of the time server according to the time obtaining command, and transmitting the current time of the time server to the computer;
(e) searching a time difference value of the destination in a time difference table, and storing the time difference value, if the user has set a new time zone and a new time format;
(f) converting the current time received from the time server into a system time of the destination according to the formula: system time of the destination=current time+time difference value of the destination, and converting a format of the current time into the new time format or a previously set time format;
(g) adjusting the system time of the computer according to the conversions;
(h) returning to step (a), if there is another computer whose system time needs to be adjusted;
(i) repeating steps (b) through (h) for the other computer, if the user has set a new time zone and a new time format for the other computer according to its destination; and
(j) repeating steps (c), (d), (f), (g) and (h) for the other computer, if the user has not set a new time zone and a new time format for the other computer according to its destination.

10. The method as described in claim 9, wherein the new time format and the previously set time format are each selected from the group consisting of a twelve-hour format and a twenty-four hour format.

11. A method for adjusting a system time of an electronic device through a network, comprising the steps of:
acquiring a time zone and time-display format for said electronic device;
acquiring a current time from a time server;
calculating a time difference value based on said time zone;
summing up said current time and said time difference value to get a new time; and
displaying said new time as said system time of said electronic device in said time-display format on said electronic device.

12. The method as described in claim 11, wherein said time zone and time-display format are acquired on one of a user-defined basis and a previously-used basis in said acquiring step.

13. The method as described in claim 11, further comprising the step of repeating all steps of said method in case of identification of another electronic device following said electronic device.
